(19) United States
(12) Patent Application Publication
(10) Pub. No.: US 2006/0042333 A1
(43) Pub. Date: Mar. 2, 2006

(54) Doorknob

(76) Inventor: Wen-Pin Wu, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/923,705

(22) Filed: Aug. 24, 2004

(51) Int. Cl. E05B 13/10

(52) U.S. Cl. 70/224

(57) ABSTRACT

A doorknob has a latch bolt assembly, a first knob assembly and a second knob assembly. The latch bolt assembly is mounted between the first and second knob assemblies and has a connector guide, a latch bolt connector assembly and a bolt. The bolt is attached to and is controlled by the latch bolt connector assembly. The first and second knob assemblies respectively have a knob, a lock cylinder, a sleeve and a lock activator. The doorknob cover engages the sleeve and limits the rotating of the sleeve and the knob. The lock activator is mounted in the sleeve and controls the latch bolt connector assembly. The lock cylinder controls the lock activator and has a keyhole. When the proper key is inserted into the keyhole, the doorknob can be unlocked.

### BACKGROUND OF THE INVENTION

1. Field of the Invention

The present invention relates to a doorknob, especially to a doorknob that has to be unlocked by a key on both sides of a door to unlatch the doorknob.

2. Description of the Prior Arts

A door has an inside and an outside and is usually mounted in an access to a building or rooms in the building. A doorknob is mounted in the door and latches and locks the door. A conventional doorknob comprises a latch bolt assembly, an outside knob assembly and an inside knob assembly. The door is locked and unlocked by controlling the latch bolt. The outside knob assembly is mounted in the outside of the door, is connected to the latch bolt and has a lock cylinder operated with a key. The inside knob assembly is mounted in the inside of the door, is connected to the latch bolt and has a button to operate the lock cylinder. However, access to some buildings has to be controlled strictly, for example, an archive for classified files, a vault, etc. To prevent files or valuables from being taken out, people entering and leaving the building have to be controlled strictly. The conventional doorknob only keeps people outside the building or room from entering but does not keep people inside the building or room from leaving. The conventional doorknob does not provide adequate security for buildings and rooms where entry and exit must be controlled because a person inside the building or the room can take anything out without any control.

To overcome the shortcomings, the present invention provides a doorknob to mitigate or obviate the aforementioned problems.

### SUMMARY OF THE INVENTION

The main objective of the present invention is to provide a doorknob that has to be operated by a proper key both from the inside and outside of a door.

The doorknob in accordance with the present invention has a latch bolt assembly, a first knob assembly and a second knob assembly. The latch bolt assembly is mounted between the first and second knob assemblies and has a connector guide, a latch bolt connector assembly and a bolt. The bolt is attached to and is controlled by the latch bolt connector assembly. The first and second knob assemblies respectively have a knob, a lock cylinder, a sleeve and a lock activator. The doorknob cover engages the sleeve and limits the rotating of the sleeve and the knob. The lock activator is mounted in the sleeve and controls the latch bolt connector assembly. The lock cylinder controls the lock activator and has a keyhole. When the proper key is inserted into the keyhole, the doorknob can be unlocked.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a doorknob in accordance with the present invention;

FIG. 2 is a perspective view in partial section of the doorknob in FIG. 1;

FIG. 3 is a top view in partial section of the doorknob in FIG. 1 mounted in a door;

FIG. 4 is a rear view in partial section of the doorknob in FIG. 1 when the doorknob is locked; and

FIG. 5 is a rear view in partial section of the doorknob in FIG. 1 when the doorknob is unlocked.

### DETAILED DESCRIPTION OF THE PREFERRED EMBODIMENTS

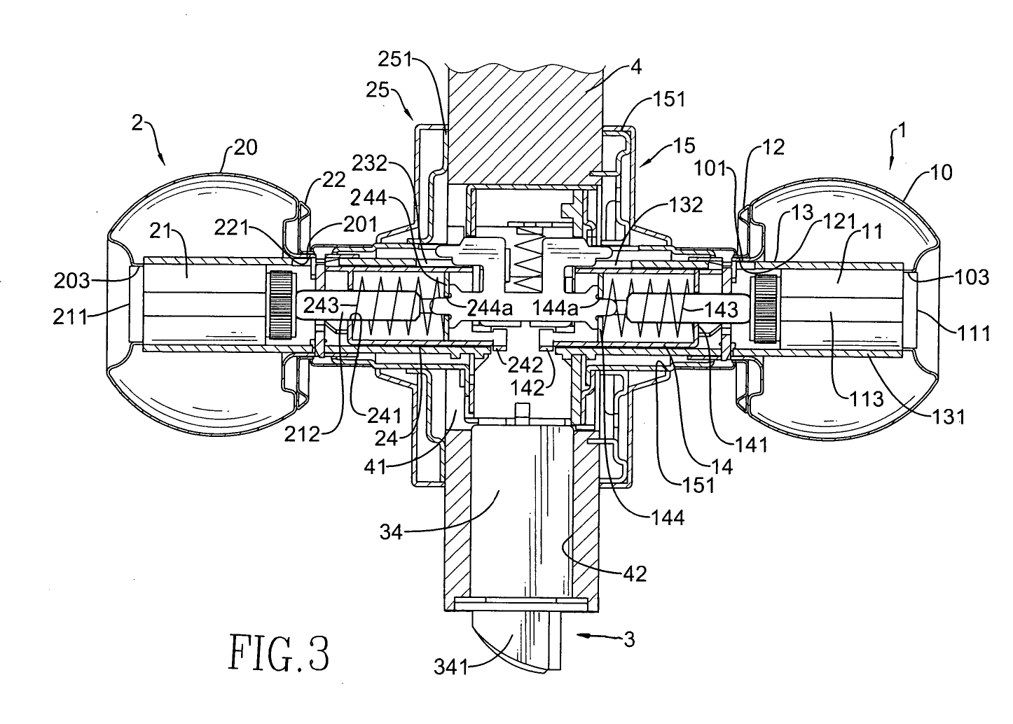

With reference to FIG. 3, a door (4) has an inside surface, an outside surface, a locking edge, a doorknob hole (41) and a latch hole (42). The doorknob hole (41) is formed through the door (4) from the inside surface to the outside surface and has openings respectively in the inside and outside surfaces of the door (4). The latch hole (42) is formed from the locking edge to the doorknob hole (41) in the door (4).

A doorknob in accordance with the present invention is mounted in the doorknob hole (41) and the latch hole (42) in the door (4) and comprises a latch bolt assembly (3), a first knob assembly (1) and a second knob assembly (2).

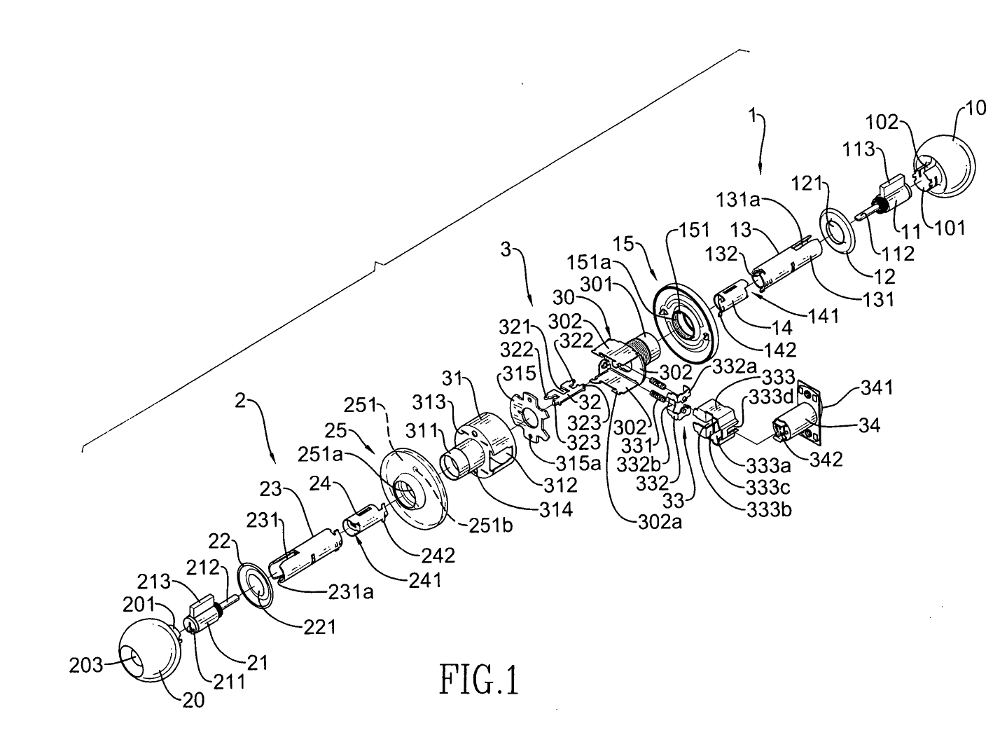

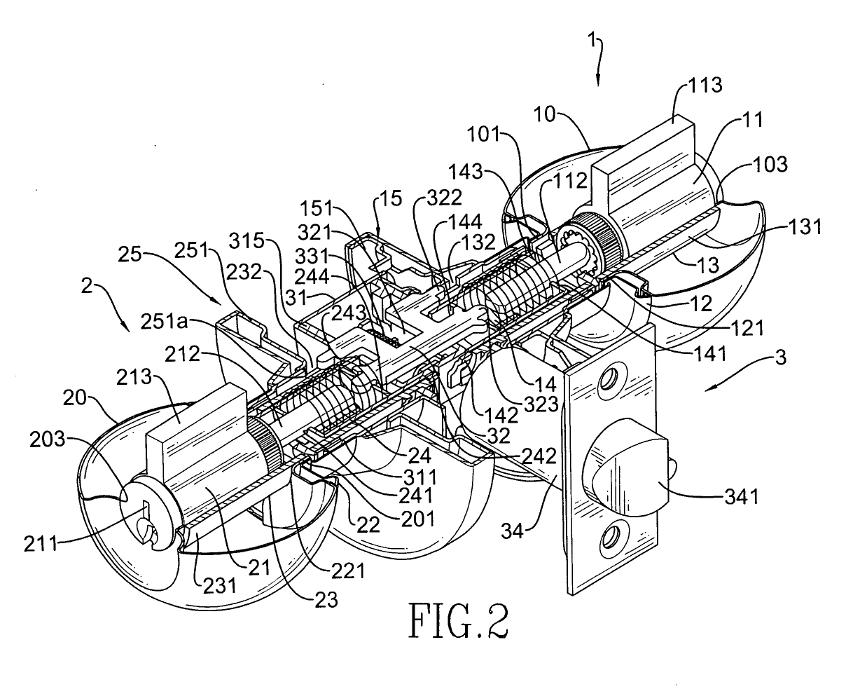

With further reference to FIGS. 1 and 2, the latch blot assembly (3) is mounted in the doorknob hole (41) and the latch hole (42) in the door (4) and has a bolt (34), a latch bolt connector assembly (33), a connector guide (32), an external bracket (31) and a internal bracket (30).

The bolt (34) is mounted in the latch hole (42) in the door (4) and has a proximal end (342), a distal end and a bolt head (341). The proximal end (342) is mounted in the door (4), and the distal end protrudes out of the door (4). The bolt head (341) slides in the bolt (34) and selectively protrudes out of the door (4) from the distal end.

The latch bolt connector assembly (33) is attached to the proximal end (342) of the bolt (34) and has a latch bolt connector (333), a seat (332) and two biasing members (331).

The latch bolt connector (333) is attached to the proximal end (342) of the bolt (34) and has an inside end (333b), a connecting end (333d), an actuating cavity (333a) and an actuating surface (333c). The inside end (333b) is optionally open. The connecting end (333d) is attached to the proximal end (342) of the bolt (34). The actuating cavity (333a) is formed between the inside end (333b) and the connecting end (333d) in the latch bolt connector (333). The actuating surface (333c) is formed on the inside end (333b).

The seat (332) is attached to the latch bolt connector (333) and has two optional pressing legs (332a) and an optional connecting leg (332b). The pressing legs (332a) are U-shaped and are attached to the actuating surface (333c) on the inside end (333b) of the latch bolt connector (333). The connecting leg (332b) is curved and is formed between the pressing legs (332a).

Each biasing member (331) is attached to the seat (332) and has an inside end and an outside end. The inside end is attached to the pressing legs (332a) of the seat (332).

The connector guide (32) is mounted in the latch bolt connector assembly (33) and has four corners, two positioning legs (322), two pivoting legs (323) and an optional slot (321). The positioning legs (322) are formed on two opposite corners. The pivoting legs (323) are formed on the other two opposite corners. The slot (321) is formed on the connector guide (32) and engages the connecting leg (332b).

The external bracket (31) is cylindrical, is mounted around the connector guide (32) and the latch bolt connector assembly (33) and has an inside end, an outside end, an outer surface, an optional neck (311), a bolt hole (312), multiple optional fastener slots (313), multiple optional fastening holes (314) and an optional fastening element (315). The neck (311) is formed on and extends coaxially from the outside end. The bolt hole (312) is formed in the outer surface and is a seat for the connecting end (333d) of the latch bolt connector assembly (33). The fastener slots (313) are formed in the outside surface. The fastening holes (314) are formed in the outside surface. The fastening element (315) is attached to the outside end inside the external bracket (31) and has multiple screw holes (315a) corresponding to the fastening holes (314) in the external bracket (31).

The internal bracket (30) is U-shaped, is connected to and mounted inside the external bracket (31) around the connector guide (32) and the latch bolt connector assembly (33) and has an inside end, an outside end, an optional neck (301) and two wings (302). The inside end has two opposite sides. The neck (301) is formed on and extends from the outside end and has an external annular thread. The wings (302) are formed on the sides of the inside end and respectively have multiple optional fasteners (302a), and the fasteners (302a) are opposite to and engage the fastener slots (313) in the external bracket (31).

The first and second knob assemblies (1, 2) are mounted on the door (4) and respectively have a cover (15, 25), a lock activator (14, 24), a sleeve (13, 23), a doorknob cover (12, 22), a lock cylinder (11, 21) and a knob (10, 20).

The covers (15, 25) are attached to the inside and outside surfaces of the door (4) around the openings of the doorknob hole (41) and respectively have an inside surface, an outside surface and an optional keyplate (151, 251). The keyplates (151, 251) are mounted in the inside surface of the covers (15, 25), are attached respectively to the inside and outside surfaces in the door (4) and respectively have an optional through hole (151a, 251a). The through holes (151a, 251a) are formed through the covers (15, 25). The through hole (151a) in the cover (15) of the first knob (1) has a threaded inner surface. The cover (25) of the second knob (2) has multiple optional fastening holes (251b) formed through the cover (25) around the through hole (251a).

The lock activators (14, 24) pass respectively through the covers (15, 25) and the internal and external brackets (30, 31), are attached to the connector guide (32) of the latch bolt assembly (30) and respectively have an inside end, an outside end, a mounting hole (141, 241), a lever (142, 242), a moveable disk (144, 244) and a biasing member (143, 243). The mounting holes (141, 241) are formed respectively in the outside ends of the lock activators (14, 24). The levers (142, 242) are formed respectively on and extend from the inside ends of the lock activators (14, 24) and press against the actuating surface (333c) of the latch bolt connector (333) of the latch bolt connector assembly (33). The moveable disks (144, 244) are formed respectively in the inside ends of the lock activators (14, 24) and respectively have a pivot hole (144a, 244a). The pivot holes (144a, 244a) are formed through the moveable disks (144, 244), and the pivoting legs (323) of the connector guide (32) are rotatably mounted respectively in the pivot holes (144a, 244a). The biasing members (143, 243) are mounted in the lock activators (14, 24) and press against the moveable disks (144, 244).

The sleeves (13, 23) are mounted respectively around the lock activators (14, 24), are attached to the connector guide (32) of the latch bolt assembly (3) and respectively have a proximal end (131, 231), a distal end and a positioning recess (132, 232). The proximal ends (131, 231) respectively have an optional notch (131a, 231a). The notches (131a, 231a) are formed in the proximal ends (131, 231). The positioning recesses (132, 232) are formed in the distal end and are attached to the positioning legs (322) of the connector guide (32) of the latch bolt assembly (3).

The doorknob covers (12, 22) are mounted respectively around the sleeves (13, 23) and respectively have a through hole (121, 221). The through holes (121, 221) in the doorknob cover (12, 22) are mounted respectively on the sleeve (13, 23).

The lock cylinders (11, 21) pass respectively through and are mounted securely in the sleeves (13, 23), respectively engage the lock activators (14, 24) and respectively have an inside end, an outside end, an outer surface, a keyhole (111, 211), an activator pin (112, 212) and an optional mounting tab (113, 213). The keyholes (111, 211) are formed in the outside end. The activator pins (112, 212) are formed on and extend axially from the inside end and respectively engage the mounting holes (141, 241) in the lock activators (14, 24). The mounting tabs (113, 213) are formed longitudinally on and extend radially out from the outer surface.

The knobs (10, 20) are mounted respectively in the doorknob covers (12, 22) of the first and second knob assemblies (1, 2), respectively engage the lock cylinders (11, 21) and respectively have an inside end, an outside end, an optional collar (101, 201), an optional notch (102, not shown) and a through hole (103, 203). The collars (101, 201) are formed on and extend from the inside end and are mounted respectively around the lock cylinders (11, 21). The notches (102, 202) are formed respectively in the collars (101, 201) and correspond respectively to and engage the mounting tabs (113, 213). The through holes (103, 203) are formed in the outside end and correspond respectively to the keyholes (111, 211) in the lock cylinders (11, 21).

With further reference to FIG. 5, the doorknob is unlocked by inserting a proper key into the keyhole (111) and turning the key cylinder (11). Because the activator pin (112) in the key cylinder (11) engages the mounting hole (141) in the lock activator (14), the lock activator (14) is turned by turning the key cylinder (11). Then the lever (142) of the lock activator (14) pushes the actuating surface (333c) in the latch bolt connector (333) of the latch bolt connector assembly (33), and the pressing leg (332a) on the seat (332) of the latch bolt connector assembly (33) is pushed. The biasing member (331) is compressed. Because the connecting end (333d) of the latch bolt connector (333) is attached to the proximal end (342) of the bolt (34), the latch bolt connector assembly (33) will draw the bolt head (341) inward. Therefore, the doorknob is unlocked.

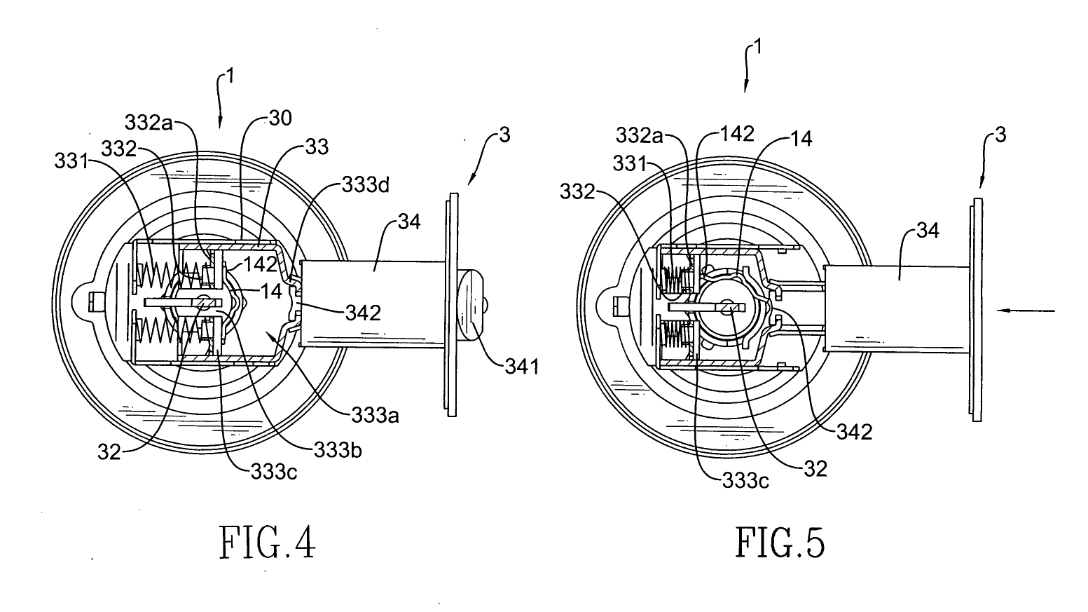

With further reference to FIG. 4, the doorknob is locked by releasing the key. When the key is released, the biasing member (331) pushes the seat (332) and the latch bolt connector (333) outward, and the bolt head (341) is pushed outward. Therefore, the doorknob is locked.

The doorknob as described the proper key to be used to unlocked and operate the doorknob without regard to whether the doorknob is operated from the inside or the outside of the door. Consequently, the doorknob can be used for a room or a building that has to be controlled strictly. The doorknob can help control enters and exits a room or a building.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A doorknob comprising
a latch bolt assembly having
a bolt having
a proximal end;
a distal end; and
a bolt head sliding in the bolt;
a latch bolt connector assembly attached to the proximal end of the bolt and having
a latch bolt connector attached to the proximal end of the bolt and having
an inside end;
a connecting end attached to the proximal end of the bolt;
an actuating cavity formed between the inside end and the connecting end in the latch bolt connector; and
an actuating surface formed on the inside end;
a seat attached to the latch bolt connector;
two biasing members attached to the seat and having
inside ends attached to the seat; and
outside ends;
a connector guide mounted in the latch bolt connector assembly and having
four corners;
two positioning legs formed on two opposite corners; and
two pivoting legs formed on the other two opposite corners;
an external bracket being cylindrical, mounted around the connector guide and the latch bolt connector assembly and having
an inside end;
an outside end;
an outer surface; and
a bolt hole formed in the outer surface and is a seat for the connecting end of the latch bolt connector assembly; and
an internal bracket being U-shaped, connected to and mounted inside the external bracket around the connector guide and the latch bolt connector assembly and having
an inside end having two opposite sides;
an outside end; and
two wings formed on the sides of the inside end; and
first and second knob assemblies respectively having
a cover having
an inside surface; and
an outside surface;
a lock activator passing through the cover and the internal and external brackets, attached to the connector guide of the latch bolt assembly and having
an inside end;
an outside end;
a mounting hole formed in the outside end of the lock activator;
a lever formed on and extending from the inside end of the lock activator and pressing against the latch bolt connector of the latch bolt connector assembly;
a moveable disk formed in the inside end of the lock activator and having a pivot hole formed through the moveable disk wherein the pivoting legs of the connector guide of the latch bolt assembly are rotatably mounted respectively in the pivot holes; and
a biasing member mounted in the lock activators and pressing against the moveable disk;
a sleeve mounted around the lock activators, attached to the connector guide of the latch bolt assembly and having
a proximal end;
a distal end; and
a positioning recess formed in the distal end and attached to the positioning legs of the connector guide of the latch bolt assembly;
a doorknob cover mounted around the sleeve and having a through hole mounted on the sleeve;
a lock cylinder passing through and mounted securely in the sleeve, engaging the lock activators and having
an inside end;
an outside end;
an outer surface;
a keyhole formed in the outside end; and
an activator pin formed on and extending axially from the inside end and engaging the mounting hole in the lock activator; and
a knob mounted in the doorknob covers, engaging the lock cylinders and having
an inside end;
an outside end; and
a through hole formed in the outside end and corresponding to the keyhole in the lock cylinder.

2. The doorknob as claimed in claim 1, wherein
the external bracket of the latch bolt assembly has
a neck formed on and extending coaxially from the outside end of the external bracket;
a bolt hole formed in the outer surface of the external bracket and being a seat for the connecting end of the latch bolt connector assembly;
multiple fastener slots formed in the outside surface of the external bracket;
multiple fastening holes formed in the outside surface of the external bracket; and
a fastening element attached to the outside end inside the external bracket and has multiple screw holes corresponding to the fastening holes in the external bracket;
the internal bracket of the latch bolt assembly has
a neck formed on and extending from the outside end of the internal bracket and having an external annular thread;
the cover of the first knob assembly has
a keyplate mounted in the inside surface of the cover and having
a through hole formed through the cover having a threaded inner surface; and
the cover of the second knob assembly has
a keyplate formed in the inside surface of the cover and having
a through hole formed through the cover; and
multiple fastening holes formed through the cover around the through hole;

3. The doorknob as claimed in claim 1, wherein
the inside end of the latch bolt connector of the latch bolt connector assembly is open;
the seat of the latch bolt connector assembly of the latch bolt assembly has
two pressing legs being U-shaped and attached to the actuating surface on the inside end of the latch bolt connector; and
a connecting leg being curved and formed between the pressing legs; and
the connector guide of the latch bolt assembly has
a slot formed on the connector guide and engaging the connecting leg of the seat of the latch bolt connector assembly.

4. The doorknob as claimed in claim 1, wherein
the lock cylinders of the first and second knob assemblies respectively have
a mounting tab formed longitudinally on and extending radially out from the outer surface;
the knobs of the first and second knob assemblies respectively have
a collar formed on and extending from the inside end and mounted around the lock cylinder; and
a notch formed on the collar and corresponding to and engaging the mounting tab.

5. The doorknob as claimed in claim 4, wherein
the sleeves of the first and second knob assemblies respectively have
a notch formed in the proximal end and engaging the mounting tab on the lock cylinder.
